(19) United States
(12) Patent Application Publication
(10) Pub. No.: US 2017/0364635 A1
(43) Pub. Date: Dec. 21, 2017

(54) MEDICAL IMAGE PROCESSING APPARATUS AND PROGRAM

(71) Applicant: KONICA MINOLTA, INC., Tokyo (JP)

(72) Inventor: Tsuyoshi KOBAYASHI, Tokyo (JP)

(73) Assignee: KONICA MINOLTA, INC., Tokyo (JP)

(21) Appl. No.: 15/622,049

(22) Filed: Jun. 13, 2017

(30) Foreign Application Priority Data
Jun. 16, 2016 (JP) 2016-119613

(51) Int. Cl. G06F 19/00; G06F 17/30; G06F 9/50; G06T 7/00; G06Q 50/24

(52) U.S. Cl. CPC G06F 19/321; G06T 7/0012; G06Q 50/24; G06F 9/505; G06F 17/30256; G06F 17/30244; G06F 19/3437

(57) ABSTRACT

A medical image processing apparatus includes: a storage unit configured to store original image data associated with a medical image; and an intermediate information generation unit configured to generate, on the basis of the original image data, intermediate information used in predetermined image processing of generating reference image data on the basis of the original image data, and to store the generated intermediate information in the storage unit.

The entire disclosure of Japanese Patent Application No. 2016-119613 filed on Jun. 16, 2016 including description, claims, drawings, and abstract are incorporated herein by reference in its entirety.

### BACKGROUND OF THE INVENTION

### Field of the Invention

The present invention relates to a medical image processing apparatus and a program.

### Description of the Related Art

In related art, various medical images such as radiation images generated by detecting X-ray dose that has passed through a subject by an X-ray photography apparatus have been used in doctor's diagnosis. In such diagnosis, a reference medical image that has facilitated visualization of a diagnosis target site of the subject on a medical image is used as well. The reference image data associated with a reference medical image is generated by analyzing original image data of the medical image and by performing image processing corresponding to analysis results onto the original image data. For example, WO 2015/157067 A discloses a technique of specifying a region of a bone tissue (bone region) on the original image data by analyzing original image data of a plain chest radiography image, and then generating reference image data obtained by suppressing the bone region, from the original image data. Generation of the reference image data in this case is performed by a series of image processing including specifying a lung-field region in the original image data, specifying the outline of the bone region by luminance distribution analysis, or the like, in the lung-field region, specifying the bone region by processing such as template matching with templates of ribs and clavicles and fitting of a curve fitting function onto the outline, and bone region suppression processing onto the original image data.

As these exemplary cases, generating reference image data needs a large volume of complicated image processing including analysis processing of original image data, and takes a long time. Therefore, the reference image data are typically generated beforehand from the time after generation of original image data until doctor's diagnosis and stored in a predetermined storage unit. At the time of doctor's diagnosis, the generated reference image data are read from the storage unit and the reference medical image is displayed.

The size of the reference image data, however, is equal to the size of the original image data, and this leads to a problem of increased data capacity needed in a case where the reference image data are stored together with the original image data in the storage unit. On the other hand, in a case where the reference image data are not stored in the storage unit and generation of the reference image data is performed at doctor's diagnosis, there would be a problem of taking a long time to generate the reference image data, hindering doctor's diagnosis at a suitable timing.

### SUMMARY OF THE INVENTION

An object of the present invention is to provide a medical image processing apparatus and a program capable of making a reference medical image associated with reference image data, to be available at a suitable timing with less data capacity.

To achieve the abovementioned object, according to an aspect, a medical image processing apparatus reflecting one aspect of the present invention comprises:

a storage unit configured to store original image data associated with a medical image; and

an intermediate information generation unit configured to generate, on the basis of the original image data, intermediate information used in predetermined image processing of generating reference image data on the basis of the original image data, and to store the generated intermediate information in the storage unit.

According to an invention of Item. 2, in the medical image processing apparatus of Item. 1, the medical image processing apparatus preferably further comprises:

a signal input unit to which a generation start signal that indicates generation of the reference image data is input; and

a reference image data generation unit configured to generate the reference image data by performing the image processing on the basis of the original image data and the intermediate information in a case where the generation start signal has been input to the signal input unit.

To achieve the abovementioned object, according to an aspect, a medical image processing apparatus reflecting one aspect of the present invention comprises:

a storage unit configured to store original image data associated with a medical image and store intermediate information used in predetermined image processing of generating reference image data on the basis of the original image data;

a signal input unit to which a generation start signal of indicating generation of the reference image data is input; and

a reference image data generation unit configured to generate the reference image data by performing the image processing on the basis of the original image data and the intermediate information in a case where the generation start signal has been input to the signal input unit.

According to an invention of Item. 4, in the medical image processing apparatus of Item. 2 or 3, the medical image processing apparatus preferably further comprises a display control unit configured to display a medical image associated with the reference image data, on a display unit.

According to an invention of Item. 5, in the medical image processing apparatus of any one of Items. 1 to 4,

the intermediate information preferably includes data indicating a region as a target for the image processing on the original image data.

According to an invention of Item. 6, in the medical image processing apparatus of Item. 5,

the original image data are preferably image data associated with the medical image including a bone of a subject,

the intermediate information preferably includes data indicating a region of the bone on the original image data, and

the reference image data are preferably generated by performing image processing of suppressing the region of the bone onto the original image data.

According to an invention of Item. 7, in the medical image processing apparatus of Item. 5,

the original image data are preferably image data associated with the medical image including an organ of a subject,

the intermediate information preferably includes data indicating a region of the organ on the original image data, and

the reference image data are preferably generated by performing image processing of suppressing the region of the organ onto the original image data.

According to an invention of Item. 8, in the medical image processing apparatus of Item. 5,

the original image data are preferably image data associated with the medical image including an artifact,

the intermediate information preferably includes data indicating a region of the artifact on the original image data, and

the reference image data are preferably generated by performing image processing of suppressing the region of the artifact onto the original image data.

According to an invention of Item. 9, in the medical image processing apparatus of any one of Items. 1 to 4,

the intermediate information preferably includes data used in processing onto each of a plurality of small regions obtained by dividing the original image data in the image processing.

According to an invention of Item. 10, in the medical image processing apparatus of Item. 9,

the intermediate information preferably includes data that indicate a deformation amount for deforming each of a plurality of small regions in first original image data so as to be aligned with a corresponding position in second original image data, among the first original image data and the second original image data that are generated at a timing different from the timing of generation of the first original image data and that relate to a same subject of the first original image data, and

the reference image data are preferably generated by image processing of initially deforming each of the plurality of small regions in the first original image data on the basis of the intermediate information and then obtaining a difference between the first original image data and the second original image data.

According to an invention of Item. 11, in the medical image processing apparatus of any one of Items. 1 to 4,

the intermediate information preferably includes data that are used in processing onto each of a plurality of pixels of the original image data in the image processing and that have a data amount smaller than the data amount of pixel data of each of the plurality of pixels.

According to an invention of Item. 12, in the medical image processing apparatus of Item. 11,

the original image data are preferably image data generated on the basis of a result of detection of radiation that has reached an inner portion of a subject,

the intermediate information preferably includes data indicating a scattered radiation content ratio of the radiation on each of the plurality of pixels of the original image data, and

the reference image data are preferably generated by image processing of subtracting a scattered radiation component of the radiation from each of the plurality of pixels of the original image data on the basis of the scattered radiation content ratio indicated by the intermediate information.

According to an invention of Item. 13, in the medical image processing apparatus of any one of Items. 1 to 11,

the original image data are preferably image data generated on the basis of a result of detection of a traveling wave that has reached an inner portion of a subject.

According to an invention of Item. 14, in the medical image processing apparatus of Item. 13,

the traveling wave is preferably radiation.

According to an invention of Item. 15, in the medical image processing apparatus of Item. 12 or 14,

the medical image is preferably a plain chest radiography image.

To achieve the abovementioned object, according to an aspect, a non-transitory recording medium storing a computer readable program reflecting one aspect of the present invention causes a computer including a storage unit configured to store original image data associated with a medical image, to achieve an intermediate information generation function of initially generating, on the basis of the original image data, intermediate information used in predetermined image processing of generating reference image data on the basis of the original image data and then storing the generated intermediate information in the storage unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating a configuration of an X-ray photography system;

FIG. 2 is a block diagram illustrating a configuration of a medical image processing apparatus;

FIGS. 3A and 3B are diagrams each illustrating an exemplary bone region suppression image;

FIG. 4 is a flowchart illustrating a control procedure of intermediate information generation processing in a case where a reference medical image is a bone region suppression image;

FIG. 5 is a flowchart illustrating a control procedure of reference image data generation processing in a case where the reference medical image is a bone region suppression image;

FIG. 6 is a flowchart illustrating a control procedure of intermediate information generation processing in a case where the reference medical image is a difference image;

FIG. 7 is a flowchart illustrating a control procedure of reference image data generation processing in a case where the reference medical image is a difference image;

FIG. 8 is a flowchart illustrating a control procedure of intermediate information generation processing in a case where the reference medical image is a scattered radiation eliminated image;

FIG. 9 is a flowchart illustrating a control procedure of reference image data generation processing in a case where the reference medical image is a scattered radiation eliminated image;

FIG. 10 is a flowchart illustrating a control procedure of intermediate information generation processing in a case where the reference medical image is an artifact suppression image; and

FIG. 11 is a flowchart illustrating a control procedure of reference image data generation processing in a case where the reference medical image is an artifact suppression image.

### DESCRIPTION OF THE PREFERRED EMBODIMENTS

Hereinafter, a medical image processing apparatus and a program according to an embodiment of the present invention will be described with reference to the drawings. However, the scope of the invention is not limited to the illustrated examples.

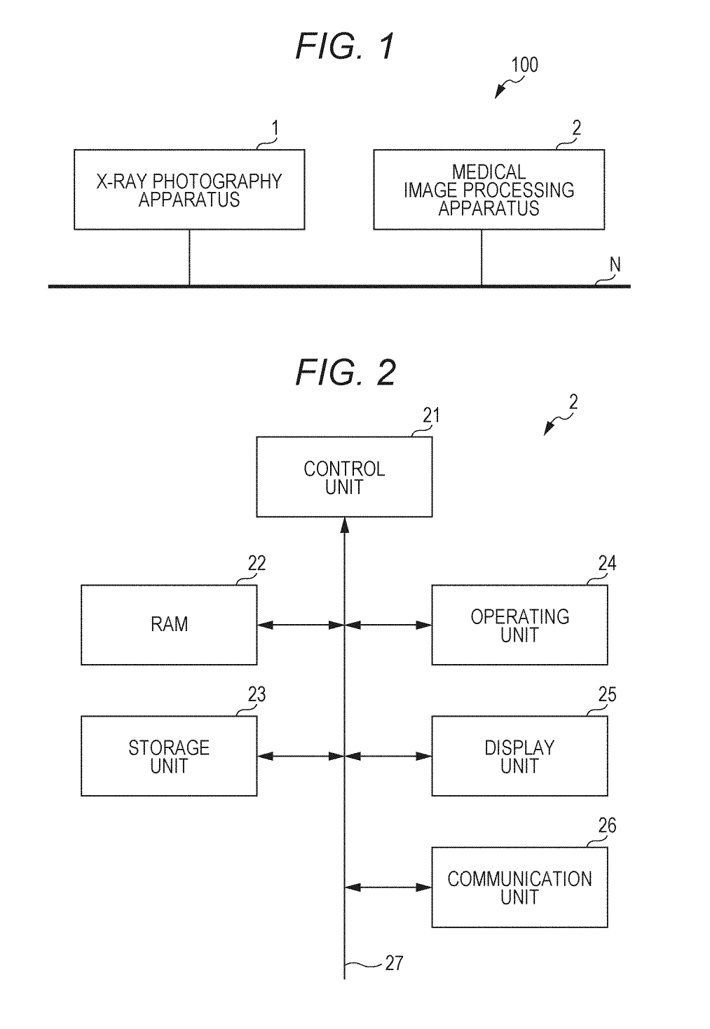

FIG. 1 is a block diagram illustrating a configuration of an X-ray photography system 100.

The X-ray photography system 100 is a system employed in medical facilities and is configured to include an X-ray photography apparatus 1 and a medical image processing apparatus 2 being connected with each other via a communication network N so as to enable data transmission and reception therebetween. The communication network N conforms to the Digital Imaging and Communication in Medicine (DICOM) standard.

The X-ray photography apparatus 1 includes an X-ray source and an X-ray detector such as a flat panel detector (FPD). The X-ray photography apparatus 1 emits an X-ray from the X-ray detector onto a subject positioned between the X-ray source and the X-ray detector, detects, using the X-ray detector, the X-ray that has reached and passed through an inner portion of the subject, and generates original image data associated with a simple X-ray image as a medical image. The X-ray photography apparatus 1 outputs the generated original image data to the medical image processing apparatus 2. According to the present embodiment, the original image data are DICOM data with the number of gradation for each of pixels being 4096 gradations (12 bit). The X-ray photography apparatus 1 is an apparatus conforming to the above-described DICOM standard, adds to the generated original image data, supplementary information such as patient information, photographing date and time, photographing site (subject site), other various types of examination information, in accordance with an input from the outside, or automatically, and outputs the data with the supplementary information to the medical image processing apparatus 2.

The medical image processing apparatus 2 is an apparatus that displays, for diagnostic reading, a medical image associated with the original image data input from the X-ray photography apparatus 1. Moreover, based on the original image data, the medical image processing apparatus 2 generates reference image data associated with the reference medical image that has facilitated visualization of the diagnosis target site, and displays the data. The medical image processing apparatus 2 is installed at a room, for example, separate from the room where the X-ray photography apparatus 1 is located, and is used for doctor's diagnosis using the medical image and the reference medical image.

The reference image data according to the reference medical image are generated by intermediate information generation processing and reference image data generation processing. The intermediate information generation processing generates intermediate information by performing a variety of predetermined analysis processing onto the original image data. The reference image data generation processing performs predetermined image processing on the original image data on the basis of the intermediate information. Among these, the intermediate information generation processing is executed at the input of the original image data, and the reference image data generation processing is executed when the reference medical image is used, for example, at the time of doctor's diagnosis.

Examples of the reference medical image include an image obtained by suppressing a bone or a specific organ on the medical images associated with the original image data, an image indicating a difference from a past medical image of a same subject, an image obtained by eliminating an X-ray scattered radiation component, and an image obtained by suppressing an artifact such as a catheter. The intermediate information generation processing and reference image data generation processing will be described in detail below. While the original image data are under preservation obligation for a predetermined period by laws and regulations, the reference image data are not a target for preservation obligation.

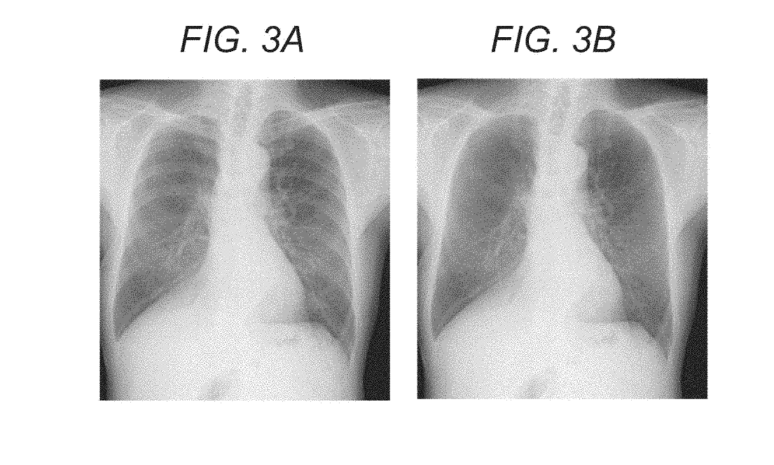

FIG. 2 is a block diagram illustrating a configuration of the medical image processing apparatus 2.

The medical image processing apparatus 2 includes a control unit 21 (intermediate information generation unit, signal input unit, reference image data generation unit, and display control unit), a RAM 22, a storage unit 23, an operating unit 24, a display unit 25, a communication unit 26, with individual components being mutually connected via a bus 27.

The control unit 21 includes a central processing unit (CPU) and executes a variety of processing such as intermediate information generation processing and reference image data generation processing in accordance with various programs such as a system program and a processing program stored in the storage unit 23.

The RAM 22 provides the control unit 21 with a working memory space and stores temporary data. The RAM 22 may include a non-volatile memory.

The storage unit 23 includes a hard disk drive (HDD) and a non-volatile memory. The storage unit 23 stores various programs and data needed for executing programs, as described above. The storage unit 23 stores original image data input from the X-ray photography apparatus 1, with intermediate information and reference image data generated by the control unit 21.

The operating unit 24 is provided with a keyboard including a cursor key, numeric input keys, various function keys, and a pointing device such as a mouse. The operating unit 24 receives a key depression signal obtained by keyboard depression operation and a mouse operation signal, and outputs these signals to the control unit 21, as input signals.

The display unit 25 includes a liquid-crystal display and an organic EL display, and displays various images in accordance with the image data and control signal input from the control unit 21.

The communication unit 26 includes a network interface, performs data transmission and reception with external devices such as the X-ray photography apparatus 1 connected to the communication network N via a switching hub.

Next, operation of the X-ray photography system 100 will be described.

In a case where the subject is photographed by the X-ray photography apparatus 1, the photography is executed in a state where the positions of the X-ray source and the X-ray detector are adjusted such that the X-ray source and the X-ray detector are positioned to face each other, and a photographing target site of the subject is positioned between the X-ray source and the X-ray detector. In a case where the photographing target site of the subject is the chest, X-ray photography is executed in a state where the subject is positioned between the X-ray source and the X-ray detector such that the back side of the subject faces the X-ray source side. The original image data of the medical image obtained by photographing is transmitted to the medical image processing apparatus 2 together with the above-described supplementary information, via the communication network N.

On the medical image processing apparatus 2, when the original image data of the medical image is received from the X-ray photography apparatus 1 by the communication unit 26, the control unit 21 stores the received original image data with the supplementary information, in the storage unit 23. Additionally, when the original image data are stored in the storage unit 23, the control unit 21 performs the above-described intermediate information generation processing onto the image data in accordance with the setting of the medical image processing apparatus 2, and then stores the generated intermediate information in the storage unit 23. Note that the intermediate information generation processing may also be performed in accordance with the input operation by the operator onto the operating unit 24.

In the present embodiment, the generated intermediate information is stored in the storage unit 23, as supplementary information conforming to the DICOM standard on the original image data file, that is, as a portion of the original image data file. Alternatively, the intermediate information may be stored in the storage unit 23, as a file separate from the original image data file, being associated with the original image data.

In any case, the intermediate information is stored in the storage unit 23 in a state where the information can be read by the control unit 21 at any timing. The intermediate information is stored in the storage unit 23 non-transiently, that is, stored without being eliminated even when the power supplied to the storage unit 23 is turned off.

Moreover, when input operation of indicating display of the reference medical image for the original image data is performed onto the operating unit 24 after generation of the intermediate information, the control unit 21 of the medical image processing apparatus 2 performs the above-described reference image data generation processing on the basis of the original image data and the intermediate information included in the supplementary information of the original image data, stored in the storage unit 23. Then, the control unit 21 displays the reference medical image associated with the generated reference image data on the display unit 25.

Hereinafter, intermediate information generation processing and reference image data generation processing will be described in accordance with individual cases where the medical image is a plain chest radiography image, and the reference medical image is (1) an image in which a bone region is suppressed (bone region suppression image), (2) an image in which a specific organ is suppressed (organ suppression image), (3) an image associated with a difference from a past medical image of the same subject (difference image), (4) an image in which X-ray scatted components have been eliminated (scattered radiation eliminated image), and (5) an image in which an artifact such as a catheter and gauze is suppressed (artifact suppression image).

[(1) Bone Region Suppression Image]

First, intermediate information generation processing and reference image data generation processing associated with a bone region suppression image as a reference medical image will be described.

In diagnosis using a plain chest radiography image, in case where the bone is not a diagnosis target, it is possible to facilitate visualization of the diagnosis target by suppressing the bone region. The bone region suppression image in which the bone region is suppressed is also referred to as a bone suppression (BS) image.

FIGS. 3A and 3B are diagrams each illustrating an exemplary bone region suppression image. FIG. 3A indicates a medical image associated with the original image data, while FIG. 3B indicates a bone region suppression image obtained by suppressing the bone region in the original image data. As illustrated in FIG. 3B, it is possible to facilitate visualization of organs other than the bone on the bone region suppression image, by suppressing the bone region within the lung-field region illustrated in a darker color.

In a case where the bone region suppression image is used as the reference medical image, intermediate information generation processing of generating intermediate information indicating the bone region in the original image data is first executed, and thereafter, reference image data generation processing of generating reference image data associated with the bone region suppression image on the basis of the original image data and intermediate information is executed when the reference medical image is displayed.

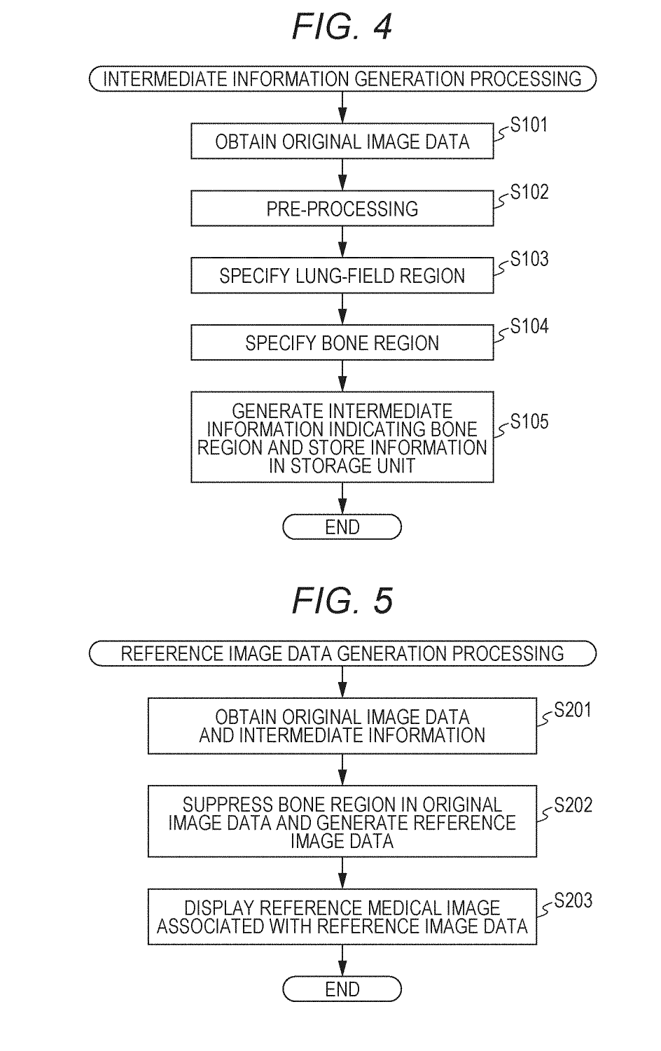

FIG. 4 is a flowchart illustrating a control procedure, executed by the control unit 21, of intermediate information generation processing in a case where the reference medical image is a bone region suppression image.

The intermediate information generation processing is started in a case where the original image data of the medical image is transmitted from the X-ray photography apparatus 1 and stored in the storage unit 23. Note that the intermediate information generation processing may be performed exclusively onto the original image data designated by input operation on the operating unit 24, among the original image data stored in the storage unit 23.

When the intermediate information generation processing is started, the control unit 21 obtains original image data as a processing target and stores the data in the RAM 22 (step S101), and then, performs predetermined pre-processing onto the original image data (step S102). Examples of the pre-processing include density correction processing, contrast enhancement processing, and edge blurring processing, necessary processing among which is executed.

The control unit 21 specifies a lung-field region on the original image data (step S103). Specifically, the control unit 21 specifies the lung-field region by executing processing such as processing of estimating a lung-field region candidate from luminance distribution of the original image data, template matching processing against a template of the lung shape, and fitting processing of a curve fitting function onto the outline of the lung-field region.

The control unit 21 specifies a bone region in the lung-field region of the original image data (step S104). Specifically, the control unit 21 specifies the bone region by executing processing such as processing of estimating an outline of the bone region on the basis of luminance distribution on the lung-field region in the original image data, template matching processing with a template of the rib and the clavicle that have been prepared, and fitting processing of a curve fitting function onto an outline of a bone region candidate. It is also allowable to perform precise inspection as to whether a specified bone region includes no errors on the basis of characteristics such as positions, shapes, sizes, density gradient, directions, of the bones, with reference to previously obtained medical information regarding the bone shapes, and to determine a portion that has been over-extracted and to remove the portion from the bone region, or add a portion that has not been extracted as false negative.

The control unit 21 generates intermediate information indicating a range of a specified bone region among the original image data and stores the generated intermediate information as supplementary information of the original image data conforming to the DICOM standard, together with the original image data, in the storage unit 23 (step S105). The intermediate information is formed of image data in which each of pixels has two gradations (one bit), the number of pixels being the same as the number of pixels of the original image data. The range of the bone region on the original image data is indicated, for example, by defining the pixel value of the pixel within the bone region range to one, while defining the pixel value of the pixel outside the bone region range to zero. In the present embodiment, the original image data are image data formed of pixels each of which being 12 bit. Accordingly, it is necessary to ensure storage capacity of two bytes (16 bit) for each of the pixels. By contrast, storage capacity of one byte (eight bit) would be sufficient for each of the pixels for the intermediate information, and thus, the data amount of the intermediate information is ½ of the data amount of the original image data.

On completion of generation of the intermediate information, the control unit 21 finishes the intermediate information generation processing. The time taken from the start to finish of the intermediate information generation processing in the present embodiment is approximately 20 seconds, although this time varies depending on the processing capability of the control unit 21 and the number of pixels of the original image data.

FIG. 5 is a flowchart illustrating a control procedure of the reference image data generation processing performed by the control unit 21 in a case where the reference medical image is a bone region suppression image.

The reference image data generation processing is started in a case where input operation of indicating display of the bone region suppression image for the original image data is initially performed onto the operating unit 24 and then a predetermined generation start signal according to the input operation has been input to the control unit 21 as a signal input unit.

When the reference image data generation processing is started, the control unit 21 obtains original image data as a processing target and intermediate information corresponding to the original image data, and stores them in the RAM 22 (step S201).

The control unit 21 suppresses, on the original image data, an image signal component of the bone region indicated by the intermediate information, and generates reference image data of the bone region suppression image as a reference medical image (step S202). Specifically, the control unit 21 obtains a density profile of a bone from partial image data for the bone region indicated by the intermediate information among the original image data, and estimates a density of the bone tissue with respect to the density profile, as needed. Subsequently, the control unit 21 generates reference image data by subtracting a value of the density profile from the bone region on the original image data.

The control unit 21 displays the reference medical image associated with the generated reference image data (herein, a bone region suppression image) on the display unit 25 (step S203).

When the processing of step S203 is finished, the control unit 21 finishes the reference image data generation processing. The time taken from the start to finish of the reference image data generation processing is approximately 0.5 second in the present embodiment. In this manner, the time needed for the reference image data generation processing is dramatically shorter than the time needed for the intermediate information generation processing.

[(2) Organ Suppression Image]

Next, intermediate information generation processing and reference image data generation processing associated with an organ suppression image as a reference medical image will be described.

In diagnosis using a plain chest radiography image, it is possible to facilitate visualization of a diagnosis target by suppressing the organ that is not the diagnosis target similarly to the above-described case of bone region suppression. Exemplary organs as targets for suppression include heart, vessels including aorta and pulmonary, trachea, bronchia, and diaphragm. In a case where the organ suppression image is used as the reference medical image, intermediate information generation processing of generating intermediate information indicating the organ region is first executed, and reference image data generation processing of generating reference image data associated with the organ suppression image on the basis of the original image data and intermediate information is then executed when the reference medical image is displayed.

The intermediate information generation processing associated with the organ suppression image is the same as the intermediate information generation processing associated with the bone region suppression image, illustrated in FIG. 4, except for the following points. That is, in the intermediate information generation processing associated with the organ suppression image, a region of an organ as a suppression target is specified in step S104 in FIG. 4, and intermediate information indicating the range of the specified organ region is generated and stored in the storage unit 23 in step S105, as the supplementary information of the original image data.

The reference image data generation processing associated with the organ suppression image is the same as the reference image data generation processing associated with the bone region suppression image, illustrated in FIG. 5, except for the following points. That is, in the reference image data generation processing associated with the organ suppression image, an image signal component of the region of the organ indicated by the intermediate information among the original image data is suppressed in step S202 in FIG. 5.

[(3) Difference Image]

Next, intermediate information generation processing and reference image data generation processing associated with a difference image as a reference medical image will be described.

In diagnosis using a plain chest radiography image, there may be a case where follow-up observation for an affected portion is performed by comparing a current medical image (hereinafter, referred to as a current image) with a medical image obtained by photographing the same site of the same subject in the past (hereinafter, referred to as a past image). In this case, by using a difference image between the current image and the past image as the reference medical image, it is possible to easily identify a portion including a change over time, among the two images.

In a case where the difference image is used as a reference medical image, intermediate information indicating a deformation amount vector for each of small regions for positioning for each of the small regions between the past image and the current image is first generated in the intermediate information generation processing. Subsequently, when the reference medical image is displayed, the reference image data generation processing is executed, in which the past image and the current image are aligned for each of the small regions on the basis of the original image data and the intermediate information, and the reference image data associated with the difference image is generated.

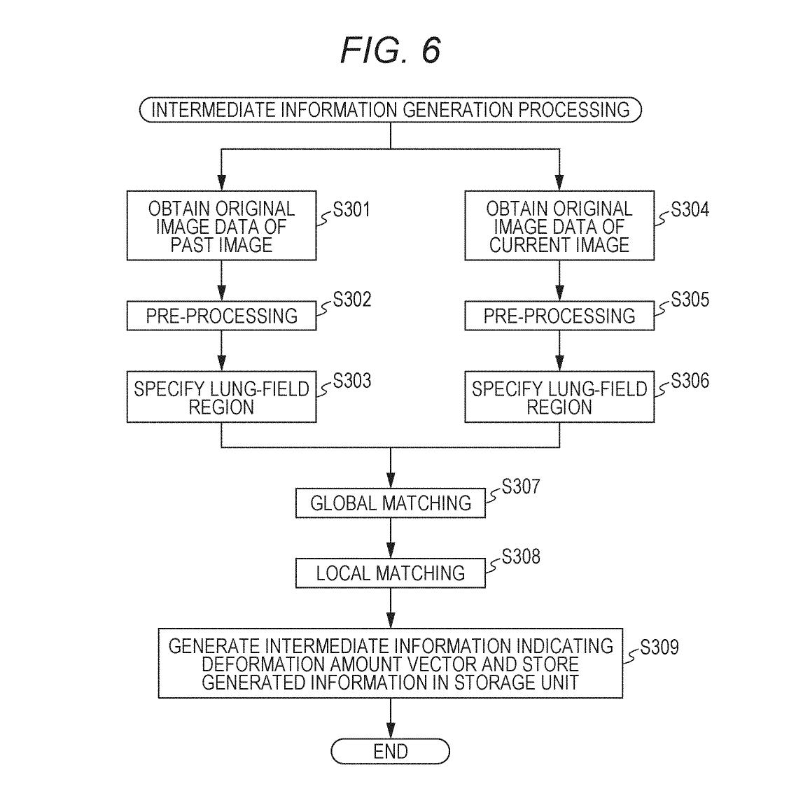

FIG. 6 is a flowchart illustrating a control procedure, executed by the control unit 21, of the intermediate information generation processing in a case where the reference medical image is a difference image. The intermediate information generation processing is executed in a case where the original image data of the medical image is transmitted from the X-ray photography apparatus 1 and stored in the storage unit 23 and past image data is designated by the input operation onto the operating unit 24. Alternatively, the past image data may be specified by the control unit 21 on the basis of the supplementary information of the original image data.

When the intermediate information generation processing is started, the control unit 21 obtains original image data of the past image and stores the obtained data in the RAM 22 (step S301), performs predetermined pre-processing onto the original image data of the past image (step S302), and specifies a lung-field region on the original image data (step S303).

Additionally, the control unit 21 obtains original image data of the current image and stores the obtained data in the RAM 22 (step S304), performs predetermined pre-processing onto the original image data of the current image (step S305), and specifies a lung-field region on the original image data (step S306).

The control unit 21 performs global positioning of the lung-field region between the current image and the past image using global matching processing (step S307). Specifically, the control unit 21 obtains a plurality of sets of characteristic corresponding points on the outline of the lung-field region and calculates a moving amount vector indicating a shift between the corresponding points. Next, affine transformation is performed onto the past image on the basis of the moving amount vector. With this process, the lung-field region of the past image is globally aligned with the lung-field region of the current image.

The control unit 21 performs local matching processing and calculates deformation amount vector needed to deform a plurality of small regions (hereinafter, referred to as a template region-of-interest (ROI)) obtained by dividing the image data of the past image so as match the corresponding region on the image data of the current image (step S308). Specifically, the control unit 21 sets a large number of templates ROI with an even pitch vertically and horizontally in the lung-field region of the original image data of the past image. Moreover, the control unit 21 sets a search ROI that is greater than the template ROI, for each of the templates ROI in the lung-field region of the original image data of the current image. Subsequently, the control unit 21 sets within the search ROI, a target region used for comparison with the template. While moving the target region, the control unit 21 obtains a cross-correlation value between the template ROI and each of the target regions, and defines the position of the target region having the highest cross-correlation value, as a position corresponding to the template ROI (corresponding position). Subsequently, the deformation amount vector indicating a shift between the template ROI and the corresponding position is calculated for each of the templates ROI.

The control unit 21 generates intermediate information indicating the deformation amount vector for each of the templates ROI and stores the generated intermediate information as supplementary information of the original image data conforming to the DICOM standard, together with the original image data, in the storage unit 23 (step S309). The data amount of the intermediate information is 1/100 of the data amount of the original image data, or below, although the amount may vary depending on the number of templates ROI to be set, or the number of bits of the data representing the deformation amount vector.

On completion of generation of the intermediate information, the control unit 21 finishes the intermediate information generation processing. The time taken from the start to finish of the intermediate information generation processing in the present embodiment is approximately two seconds, although this time varies depending on the processing capability of the control unit 21 and the number of pixels of the original image data.

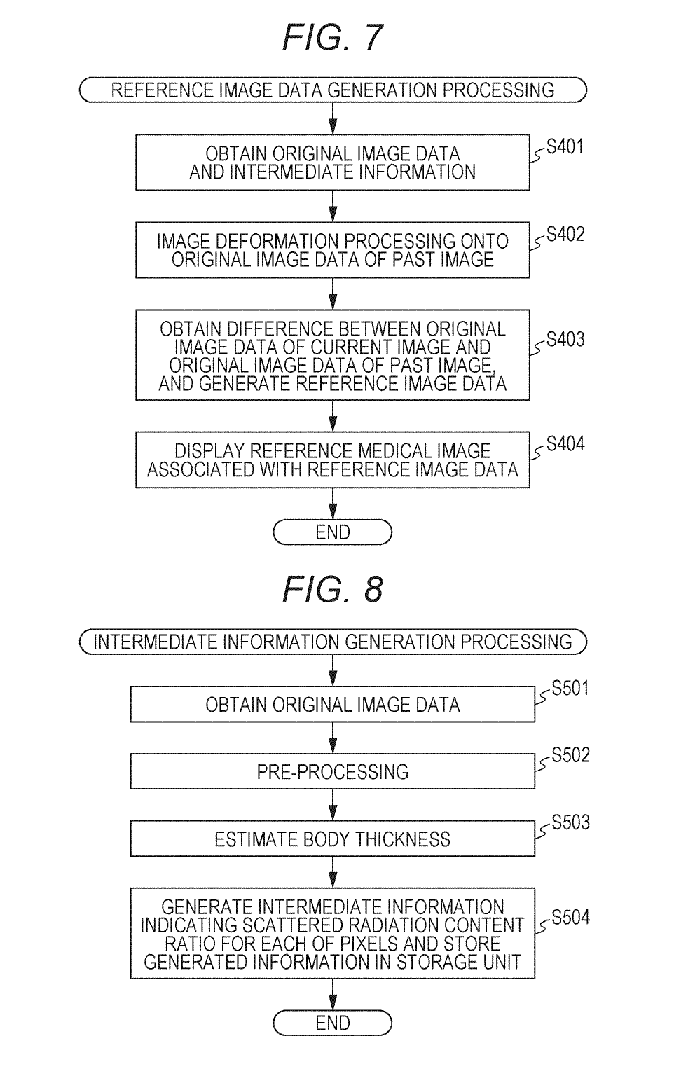

FIG. 7 is a flowchart illustrating a control procedure of reference image data generation processing performed by the control unit 21 in a case where the reference medical image is a difference image.

The reference image data generation processing is started in a case where input operation of indicating display of the difference image for the original image data is initially performed onto the operating unit 24 and then a predetermined generation start signal according to the input operation is input to the control unit 21 as a signal input unit.

When the reference image data generation processing is started, the control unit 21 obtains original image data as a processing target and the intermediate information corresponding to the original image data, and stores them in the RAM 22 (step S401).

The control unit 21 performs onto the original image data of the past image, processing of deforming the past image on the basis of the deformation amount vector for each of the templates ROI indicated by the intermediate information (step S402). Specifically, on the basis of the deformation amount vector for each of the templates ROI, the control unit 21 calculates the deformation amount vector for each of the pixels using polynomial fitting, or the like, performs warping processing on the pixel of the original image data of the past image on the basis of the deformation amount vector of each of the pixels, and aligns the position between the current image and the past image.

The control unit 21 obtains a difference between the original image data of the current image and the original image data of the past image, generates reference image data associated with the difference image as the reference medical image (step S403), and displays a reference medical image (herein, difference image) associated with the generated reference image data, on the display unit 25 (step S404).

When the processing of step S404 is finished, the control unit 21 finishes the reference image data generation processing. The time taken from the start to finish of the reference image data generation processing is 0.1 second or below in the present embodiment. In this manner, the time needed for the reference image data generation processing is dramatically shorter than the time needed for the intermediate information generation processing.

While the past image is deformed to be aligned with the current image and thereafter, the difference image is generated in the above, it is also allowable to deform the current image to be aligned with the past image.

[(4) Scattered Radiation Eliminated Image]

Next, intermediate information generation processing and reference image data generation processing associated with a scattered radiation eliminated image as a reference medical image will be described.
In a plain chest radiography image, noise due to scattered X-ray (scattered radiation) caused at the time of passing through the subject might lead to deterioration of image quality. To cope with this, there is a known technique of performing photographing using a grid that eliminates scattered radiation incident with an incident angle of a predetermined value or above with respect to the radiation incident angle, attached on a radiation incident surface of the FPD of the X-ray photography apparatus 1. A portable type FPD, however, has difficulty in performing alignment between an X-ray tube lamp of the radiation emission device and the grid, and accordingly, there might be a case where scattered radiation elimination effects cannot be achieved by the grid. In this case, predetermined image processing is performed on the original image data of the medical image and the scattered radiation eliminated image, which is an image from which scattered radiation has been eliminated similarly to the image photographed using a grid, is used as the reference medical image.

In a case where the scattered radiation eliminated image is used as the reference medical image, intermediate information indicating a scattered radiation content ratio on each of the pixels of the original image data is generated in the intermediate information generation processing, and reference image data generation processing of generating reference image data from which a scattered radiation component has been eliminated, on the basis of the intermediate information, is executed, when the reference medical image is displayed.

FIG. 8 is a flowchart illustrating a control procedure, executed by the control unit 21, of intermediate information generation processing in a case where the reference medical image is a scattered radiation eliminated image.

When the intermediate information generation processing is started, the control unit 21 obtains original image data and stores the data in the RAM 22 (step S501), and performs predetermined pre-processing onto the original image data (step S502).

The control unit 21 estimates a body thickness of the subject on the basis of the original image data (step S503). Specifically, the control unit 21 sets a first ROI in a region where the pixel value is relatively small among the original image data, and sets a second ROI in a region where the pixel value is larger, with respect to the first ROI. On the plain chest radiography image, the first ROI is set on a site where the pixel value is small, such as spinal column and vertebral body (near-white region in FIG. 3B). In an image of the site other than the chest, the first ROI may be set to bone regions such as skull in the head, the upper arm bone and the thigh bone in the arm and the leg. On the plain chest radiography image, the second ROI is set to the lung-field region (near-black region in FIG. 3B), for example. Subsequently, the control unit 21 estimates the body thickness of the subject on the original image data from a difference between two peaks appearing in a histogram of pixel values of the first ROI and the second ROI, on the basis of a corresponding relationship between the peak and the body thickness obtained beforehand.

On the basis of the estimated body thickness and the pixel value of each of the pixels of the original image data, the control unit 21 calculates a scattered radiation content ratio for each of the pixels, and stores the intermediate information indicating the scattered radiation content ratio in the storage unit 23 together with the original image data, as supplementary information of the original image data conforming to the DICOM standard (step S504). By setting the number bits of the data associated with the scattered radiation content ratio of each of the pixels in the intermediate information to eight bits or below, it is possible to suppress the storage capacity needed to store each of the pixel data of the intermediate information to one byte, which is ½ of the storage capacity (two bytes) needed to store pixel data (12 bits) of each of the pixels of the original image data. That is, it is possible to reduce the data amount of the intermediate information to ½ of the original image data size.

On completion of generation of the intermediate information, the control unit 21 finishes the intermediate information generation processing. The time taken from the start to finish of the intermediate information generation processing in the present embodiment is approximately one second, although this time varies depending on the processing capability of the control unit 21 and the number of pixels of the original image data.

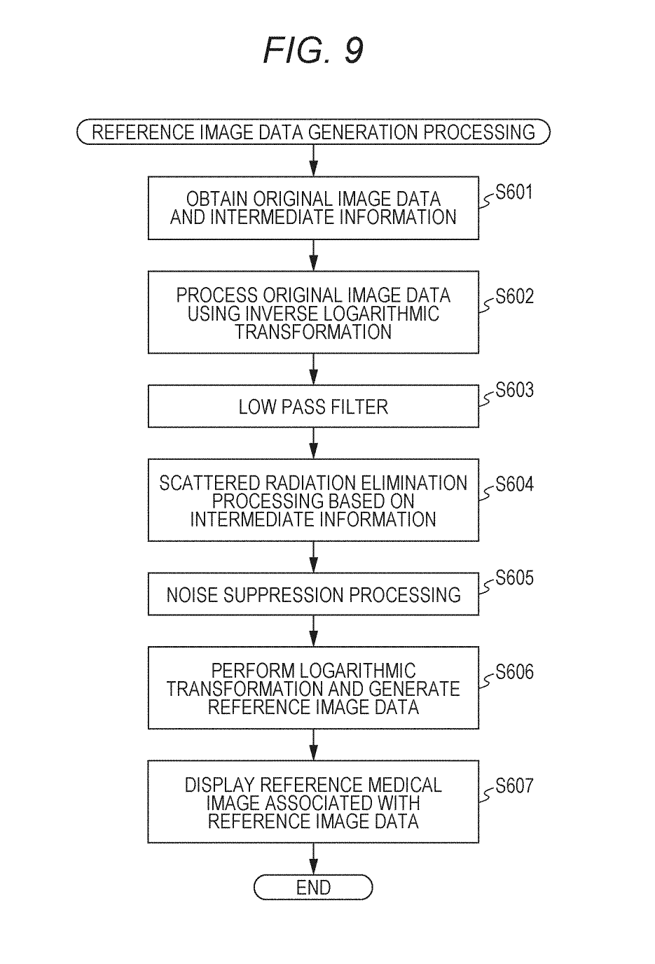

FIG. 9 is a flowchart illustrating a control procedure of the reference image data generation processing performed by the control unit 21 in a case where the reference medical image is a scattered radiation eliminated image.

The reference image data generation processing is started in a case where input operation of indicating display of the scattered radiation eliminated image for the original image data is initially performed onto the operating unit 24 and then a predetermined generation start signal according to the input operation has been input to the control unit 21 as a signal input unit.

When the reference image data generation processing is started, the control unit 21 obtains original image data as a processing target and intermediate information corresponding to the original image data, and stores them in the RAM 22 (step S601).

The control unit 21 performs inverse logarithmic transformation processing onto the original image data (step S602). The pixel value of the original image data generated by the X-ray photography apparatus 1 is a value obtained by performing logarithmic transformation on the value of X-ray incident radiation dose. Accordingly, the control unit 21 obtains data of the incident radiation dose regarding each of the pixels of the original image data by performing inverse logarithmic transformation onto the pixel value.

The control unit 21 performs low pass filter processing onto the original image data that have undergone inverse logarithmic transformation and generates low frequency image data in which the components other than the scattered radiation component are suppressed (step S603).

The control unit 21 calculates the scattered radiation component for each of the pixels on the basis of the scattered radiation content ratio of each of the pixels indicated by the intermediate information and on the basis of the low frequency image data generated in step S603, and performs scattered radiation elimination processing of subtracting the scattered radiation component from the original image data that have undergone inverse logarithmic transformation in step S602 (step S604).

The control unit 21 performs noise suppression processing (step S605) onto the image data after scattered radiation elimination processing, generated in step S604. Since the scattered radiation component has been subtracted, the image data generated in step S604 has generally small pixel values compared with the original image data. Accordingly, there might be a case where the S/N ratio with respect to the X-ray quantum noise is deteriorated. In this case, it is possible to suppress deterioration of image quality by noise suppression processing in the present step. As noise suppression processing, it is possible to execute, for example, processing of applying a statistical filter such as a Wiener filter to the pixel value of each of the pixels.

The control unit 21 generates reference image data associated with the scattered radiation eliminated image by performing logarithmic transformation on the pixel value of the image data that have undergone noise suppression processing (step S606), and displays the reference medical image associated with the generated reference image data (herein, scattered radiation component eliminated image) on the display unit 25 (step S607).

When the processing of step S607 is finished, the control unit 21 finishes the reference image data generation processing. The time taken from the start to finish of the reference image data generation processing is approximately 0.1 second in the present embodiment. In this manner, the time needed for the reference image data generation processing is dramatically shorter than the time needed for the intermediate information generation processing.

[(5) Artifact Suppression Image]

Next, intermediate information generation processing and reference image data generation processing associated with an artifact suppression image as a reference medical image will be described.

In the diagnosis using a plain chest radiography image that captured the subject together with an artifact including medical tubes such as a catheter, it is possible to facilitate visualization of the diagnosis target by using an artifact suppression image that has suppressed the artifact.

In a case where an artifact suppression image is used as the reference medical image, intermediate information generation processing of generating intermediate information indicating the artifact region is initially executed, and reference image data generation processing of generating reference image data associated with the artifact suppression image on the basis of the intermediate information is then executed when the reference medical image is displayed.

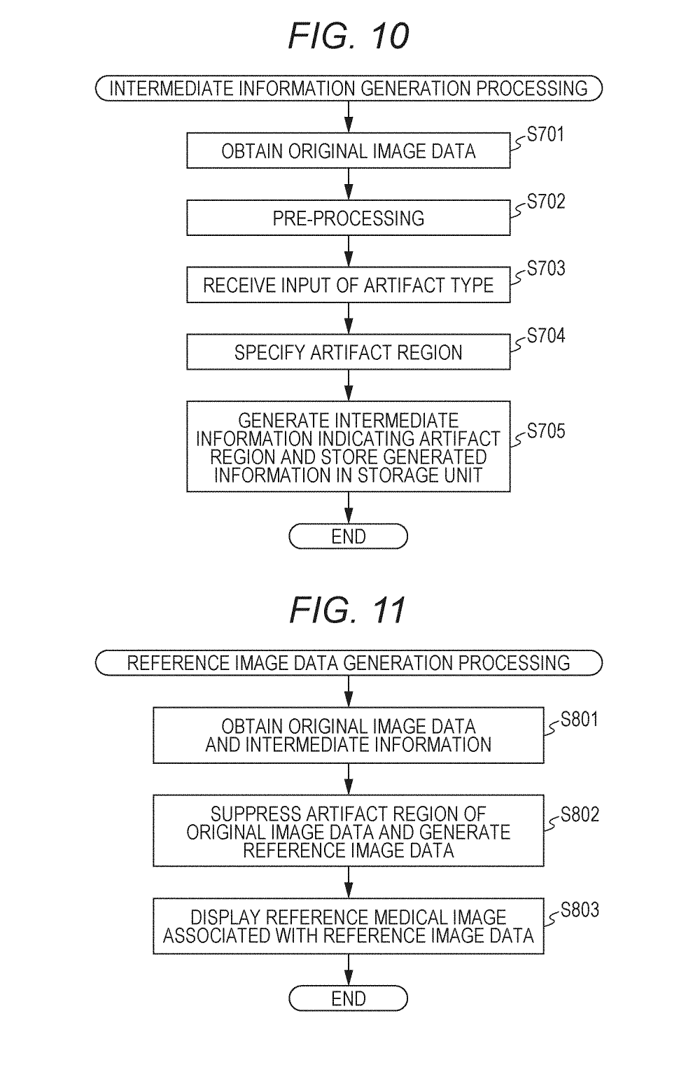

FIG. 10 is a flowchart illustrating a control procedure, executed by the control unit 21, of intermediate information generation processing in a case where the reference medical image is an artifact suppression image.

When the intermediate information generation processing is started, the control unit 21 obtains original image data as a processing target and stores the obtained data in the RAM 22 (step S701), and performs predetermined pre-processing onto the original image data (step S702).

The control unit 21 receives input operation of designating the type of the artifact, onto the operating unit 24 (step S703). Herein, the control unit 21 displays a graphical user interface (GUI) for performing input operation of designating the type of artifact used (or the size of the artifact (tube diameter, or the like) according to the type) on the display unit 25, and receives the input operation onto the operating unit 24.

On the basis of the type of the artifact designated by the input operation, the control unit 21 analyzes the original image data and specifies an artifact region on the original image data (step S704). Specifically, the control unit 21 performs spatial frequency enhancement onto the original image data using a spatial frequency corresponding to the size for the type of artifact designated by input operation, thereby generating outline enhanced image data in which the outline of the artifact is enhanced. For example, when setting this spatial frequency for a tube-like artifact, it is possible to effectively enhance the outline of the artifact by setting the value that is a diameter of the tube or below. Subsequently, the control unit 21 performs processing of detecting an outline of the artifact on the outline enhanced image data, thereby specifying the region surrounded by the outline to be an artifact region.

The control unit 21 generates intermediate information indicating a range of the specified artifact region among the original image data and stores the generated intermediate information as supplementary information of the original image data conforming to the DICOM standard, together with the original image data, in the storage unit 23 (step S705). The intermediate information is formed of image data in which each of pixels has two gradations (one bit), the number of pixels being the same as the number of pixels of the original image data. The range of the artifact region is indicated, for example, by defining the pixel value of the pixel within the artifact region range to one, while defining the pixel value of the pixel outside the artifact region range to zero. In the present embodiment, the original image data are image data formed of pixels each of which being 12 bit. Accordingly, it is necessary to ensure storage capacity of two bytes (16 bit) for each of the pixels. By contrast, storage capacity of one byte (eight bit) would be sufficient for each of the pixels for the intermediate information, and thus, the data amount of the intermediate information is ½ of the data amount of the original image data.

On completion of generation of the intermediate information, the control unit 21 finishes the intermediate information generation processing. The time taken from the start to finish of the intermediate information generation processing in the present embodiment is approximately 20 seconds, although this time varies depending on the processing capability of the control unit 21 and the number of pixels of the original image data.

FIG. 11 is a flowchart illustrating a control procedure of the reference image data generation processing performed by the control unit 21 in a case where the reference medical image is an artifact suppression image.

The reference image data generation processing is started in a case where input operation of indicating display of the artifact region suppression image for the original image data is initially performed onto the operating unit 24 and then a predetermined generation start signal according to the input operation is input to the control unit 21 as a signal input unit.

When the reference image data generation processing is started, the control unit 21 obtains original image data as a processing target and intermediate information corresponding to the original image data, and stores them in the RAM 22 (step S801).

The control unit 21 suppresses, on the original image data, an image signal component of the artifact region indicated by the intermediate information, and generates reference image data of the artifact region suppression image as a reference medical image (step S802). Specifically, the control unit 21 obtains a density profile of the artifact from partial image data of the artifact region indicated by the intermediate information among the original image data, and eliminates a spatial high-frequency component such as noise by applying a low pass filter to the density profile as needed. Subsequently, the control unit 21 generates reference image data by subtracting a value of the density profile from the artifact region on the original image data.

The control unit 21 displays the reference medical image associated with the generated reference image data (herein, artifact suppression image) on the display unit 25 (step S803).

When the processing of step S803 is finished, the control unit 21 finishes the reference image data generation processing. The time taken from the start to finish of the reference image data generation processing is approximately 0.5 second in the present embodiment. In this manner, the time needed for the reference image data generation processing is dramatically shorter than the time needed for the intermediate information generation processing.

As described above, the medical image processing apparatus 2 according to the present embodiment includes the storage unit 23 configured to store original image data associated with the medical image, and the control unit 21 (intermediate information generation unit) configured to generate, on the basis of the original image data, intermediate information used in predetermined image processing of generating reference image data on the basis of the original image data, and to store the intermediate information in the storage unit 23.

The data amount of the intermediate information stored in the storage unit 23 in this configuration is smaller than the data amount of the reference image data. Accordingly, it is possible to make the reference medical image available with a smaller data capacity compared with a case where the reference image data itself is stored in the storage unit 23. Moreover, according to the above-described configuration, it is possible to generate the reference image data by image processing in a short time on the basis of the original image data and the intermediate information stored in the storage unit 23. That is, it is possible to make the reference medical image associated with the reference image data available at a suitable timing in doctor's diagnosis using the reference image. Moreover, according to the above-described configuration, it is possible to easily grasp and verify the reference image data have been (are) generated by what type of image processing applied to the original image data, on the basis of the intermediate information stored in the storage unit 23.

Moreover, the generation start signal of indicating generation of the reference image data is input to the control unit 21 (signal input unit). In a case where the generation start signal has been input, the control unit 21 performs image processing on the basis of the original image data and the intermediate information, thereby generating the reference image data (reference image data generation unit). With this configuration, the reference image data generation processing is performed at a limited time when the reference image data is needed, making it possible to suppress the processing amount by the control unit 21 to the required minimum amount.

The medical image processing apparatus 2 according to the present embodiment includes the storage unit 23 configured to store the original image data associated with the medical image and store intermediate information used in predetermined image processing of generating reference image data on the basis of the original image data, and includes the control unit 21. The generation start signal of indicating generation of the reference image data is input to the control unit 21. In a case where the generation start signal has been input to the control unit 21, the control unit 21 performs image processing on the basis of the original image data and the intermediate information, thereby generating the reference image data (reference image data generation unit).

With this configuration, it is possible to make the reference medical image available with a smaller data capacity compared with a case where the reference image data itself is stored in the storage unit 23. Moreover, according to the above-described configuration, it is possible to generate the reference image data by image processing in a short time on the basis of the original image data and the intermediate information stored in the storage unit 23. That is, it is possible to make the reference medical image associated with the reference image data available at a suitable timing in doctor's diagnosis using the reference image.

The control unit 21 displays a medical image associated with the reference image data, on the display unit 25 (display control unit). With this configuration, it is possible to display the reference medical image at a suitable timing on the medical image processing apparatus 2.

Additionally, the intermediate information includes data indicating a region as a target for image processing on the original image data. The data amount of the intermediate information is much smaller than the data amount of the reference image data. Accordingly, it is possible to dramatically reduce the data capacity needed, compared with a case where the reference image data itself is stored in the storage unit 23.

Moreover, the original image data are image data associated with the medical image including a bone of the subject, the intermediate information includes data indicating the region of the bone on the original image data, and the reference image data are generated by performing image processing of suppressing the region of the bone onto the original image data. With this process, it is possible to make the bone region suppression image available at a suitable timing with a small data capacity.

Moreover, the original image data are image data associated with the medical image including an organ of the subject, and the reference image data are generated by performing image processing of suppressing the region of the organ onto the original image data. With this process, it is possible to make the organ suppression image available at a suitable timing with a small data capacity.

Moreover, the original image data are image data associated with the medical image including an artifact, the intermediate information includes data indicating the region of the artifact on the original image data, and the reference image data are generated by performing image processing of suppressing the region of the artifact onto the original image data. With this process, it is possible to make the artifact suppression image available at a suitable timing with a small data capacity.

Moreover, the intermediate information includes data used in processing onto each of a plurality of small regions obtained by dividing the original image data in image processing. The number of pieces of data and the data amount of the intermediate information are much smaller than the number of pieces of data and the data amount of the reference image data. Accordingly, it is possible to dramatically reduce the data capacity needed, compared with a case where the reference image data itself is stored in the storage unit 23.

Moreover, the intermediate information includes data that indicate a deformation amount for deforming each of a plurality of small regions in the original image data of the past image so as to be aligned with a corresponding position in the original image data of the current image, among the original image data of the past image and the original image data of the current image that are generated after the original image data of the past image and that relate to the same subject of the original image data of the past image, while the reference image data are generated by image processing of initially deforming each of the plurality of small regions in the original image data of the past image on the basis of the intermediate information and then obtaining a difference between the original image data of the past image and the original image data of the current image. With this process, it is possible to make the difference image available at a suitable timing with a small data capacity.

Moreover, the intermediate information includes data that are used in processing onto each of a plurality of pixels of the original image data in image processing and that have a data amount smaller than the data amount of the pixel data of each of the plurality of pixels. With the intermediate information being stored in the storage unit 23, it is possible to dramatically reduce the data capacity needed, compared with a case where the reference image data itself is stored in the storage unit 23.

Moreover, the original image data are image data generated on the basis of a result of detection of radiation that has reached an inner portion of the subject, the intermediate information includes data indicating a scattered radiation content ratio of the radiation on each of the plurality of pixels of the original image data, and the reference image data are generated by image processing of subtracting a scattered radiation component of the radiation from each of the plurality of pixels of the original image data on the basis of the scattered radiation content ratio indicated by the intermediate information. With this process, it is possible to make the scattered radiation eliminated image available at a suitable timing with a small data capacity.

Moreover, with the medical image processing apparatus 2 according to the present embodiment, it is possible to generate reference image data for the original image data associated with the radiation image generated on the basis of the result of detection of the radiation that has reached the inner portion of the subject.

Moreover, with the medical image processing apparatus 2 according to the present embodiment, it is possible to make a various reference medical images used in diagnosis associated with a plain chest radiography image, to be available at a suitable timing with less data capacity.

Moreover, a program according to the present embodiment causes a computer including the storage unit 23 configured to store the original image data associated with the medical image, to achieve an intermediate information generation function of initially generating, on the basis of the original image data, intermediate information used in predetermined image processing of generating reference image data on the basis of the original image data, and then storing the generated intermediate information in the storage unit 23. With this program, it is possible to make a reference medical image associated with reference image data to be available at a suitable timing with less data capacity.

The present invention is not limited to the above-described embodiments and modification examples but may be modified in a variety of ways.

For example, while the above-described embodiment illustrates an exemplary case where the medical image processing apparatus 2 includes the display unit 25 and the reference medical image is displayed on the medical image processing apparatus 2, the configuration is not intended to be limited to this case. The reference image data generated on the medical image processing apparatus 2 may be output to a display device separate from the medical image processing apparatus 2 and the reference medical image may be displayed on this separate display device.

Moreover, while the above-described embodiment illustrates an exemplary case where both generation of the intermediate information and generation of the reference medical image are performed on the medical image processing apparatus 2, the configuration is not intended to be limited to this case. Generation of the intermediate information and generation of the reference medical image may be performed on separate medical image processing apparatuses. Specifically, a first medical image processing apparatus configured to generate intermediate information on the basis of the original image data and to store the generated intermediate information in a storage unit may be provided separately from a second medical image processing apparatus configured to generate reference image data on the basis of the original image data and the intermediate information output from the first medical image processing apparatus.

Moreover, the intermediate information generated on the medical image processing apparatus 2 may be stored in the storage unit 23 after data compression (high-efficiency encoding) is performed onto the intermediate information. A preferable data compression type would be a lossless compression system from a viewpoint of maintaining reliability of the reference medical image. In particular, in a case where the intermediate information is the data indicating the image processing target region in the original image data, or the like, each of the pixel data of the intermediate information is represented by one-bit data of any of zero and one, and a section that continuously contains the same data tends to be long. Accordingly, it is possible to compress the data with extremely high compression rate by run length encoding, for example.

Moreover, while the above-described embodiment illustrates an exemplary case where the plain chest radiography image is used as a medical image, the medical image is not limited to this but may be, for example, a sectional image of X-ray CT and a contrast X-ray image.

Moreover, while the above-described embodiment illustrates an exemplary case where radiation that passes through the subject is used as a traveling wave that is used for generation of the original image data and that reaches the inner portion of the subject, the configuration is not intended to be limited to this.

The traveling wave may be a traveling wave, for example, that is reflected after reaching the inner portion of the subject, such as a sound wave. Accordingly, the original image data may be the image data generated by emitting ultrasound from an ultrasound probe of an ultrasound diagnosis apparatus onto the inner portion of the subject, receiving a reflected ultrasound, and processing an obtained reception signal.

Moreover, the original image data may be the data generated by a magnetic resonance imaging (MRI) method that uses a microwave as a traveling wave.

Although the present invention has been described and illustrated in detail, it is clearly understood that the same is by way of illustrated and example only and is not to be taken by way of limitation, the scope of the present invention being interpreted by terms of the appended claims. The scope of the present invention includes the scope of the invention described in the appended claims and the scope of their equivalents of the appended claims.

What is claimed is:

1. A medical image processing apparatus comprising:
a storage unit configured to store original image data associated with a medical image; and
an intermediate information generation unit configured to generate, on the basis of the original image data, intermediate information used in predetermined image processing of generating reference image data on the basis of the original image data, and to store the generated intermediate information in the storage unit.

2. The medical image processing apparatus according to claim 1, further comprising:
a signal input unit to which a generation start signal that indicates generation of the reference image data is input; and
a reference image data generation unit configured to generate the reference image data by performing the image processing on the basis of the original image data and the intermediate information in a case where the generation start signal has been input to the signal input unit.

3. A medical image processing apparatus comprising:
a storage unit configured to store original image data associated with a medical image and store intermediate information used in predetermined image processing of generating reference image data on the basis of the original image data;
a signal input unit to which a generation start signal of indicating generation of the reference image data is input; and
a reference image data generation unit configured to generate the reference image data by performing the image processing on the basis of the original image data and the intermediate information in a case where the generation start signal has been input to the signal input unit.

4. The medical image processing apparatus according to claim 2, further comprising a display control unit configured to display a medical image associated with the reference image data, on a display unit.

5. The medical image processing apparatus according to claim 1,
wherein the intermediate information includes data indicating a region as a target for the image processing on the original image data.

6. The medical image processing apparatus according to claim 5,
wherein the original image data are image data associated with the medical image including a bone of a subject,
the intermediate information includes data indicating a region of the bone on the original image data, and
the reference image data are generated by performing image processing of suppressing the region of the bone onto the original image data.

7. The medical image processing apparatus according to claim 5,
wherein the original image data are image data associated with the medical image including an organ of a subject,
the intermediate information includes data indicating a region of the organ on the original image data, and
the reference image data are generated by performing image processing of suppressing the region of the organ onto the original image data.

8. The medical image processing apparatus according to claim 5,
wherein the original image data are image data associated with the medical image including an artifact,
the intermediate information includes data indicating a region of the artifact on the original image data, and
the reference image data are generated by performing image processing of suppressing the region of the artifact onto the original image data.

9. The medical image processing apparatus according to claim 1,
wherein the intermediate information includes data used in processing onto each of a plurality of small regions obtained by dividing the original image data in the image processing.

10. The medical image processing apparatus according to claim 9,
wherein the intermediate information includes data that indicate a deformation amount for deforming each of a plurality of small regions in first original image data so as to be aligned with a corresponding position in second original image data, among the first original image data and the second original image data that are generated at a timing different from the timing of generation of the first original image data and that relate to a same subject of the first original image data, and
the reference image data are generated by image processing of initially deforming each of the plurality of small regions in the first original image data on the basis of the intermediate information and then obtaining a difference between the first original image data and the second original image data.

11. The medical image processing apparatus according to claim 1,
wherein the intermediate information includes data that are used in processing onto each of a plurality of pixels of the original image data in the image processing and that have a data amount smaller than the data amount of pixel data of each of the plurality of pixels.

12. The medical image processing apparatus according to claim 11,
wherein the original image data are image data generated on the basis of a result of detection of radiation that has reached an inner portion of a subject,
the intermediate information includes data indicating a scattered radiation content ratio of the radiation on each of the plurality of pixels of the original image data, and
the reference image data are generated by image processing of subtracting a scattered radiation component of the radiation from each of the plurality of pixels of the original image data on the basis of the scattered radiation content ratio indicated by the intermediate information.

13. The medical image processing apparatus according to claim 1,
wherein the original image data are image data generated on the basis of a result of detection of a traveling wave that has reached an inner portion of a subject.

14. The medical image processing apparatus according to claim 13,
wherein the traveling wave is radiation.

15. The medical image processing apparatus according to claim 12,
wherein the medical image is a plain chest radiography image.

16. A non-transitory recording medium storing a computer readable program that causes a computer including a storage unit configured to store original image data associated with a medical image, to achieve an intermediate information generation function of initially generating, on the basis of the original image data, intermediate information used in predetermined image processing of generating reference image data on the basis of the original image data and then storing the generated intermediate information in the storage unit.

17. The medical image processing apparatus according to claim 3,
wherein the intermediate information includes data indicating a region as a target for the image processing on the original image data.

18. The medical image processing apparatus according to claim 3,
wherein the intermediate information includes data used in processing onto each of a plurality of small regions obtained by dividing the original image data in the image processing.

19. The medical image processing apparatus according to claim 3,
wherein the intermediate information includes data that are used in processing onto each of a plurality of pixels of the original image data in the image processing and that have a data amount smaller than the data amount of pixel data of each of the plurality of pixels.

20. The medical image processing apparatus according to claim 3,
wherein the original image data are image data generated on the basis of a result of detection of a traveling wave that has reached an inner portion of a subject.
